(19) United States
(12) Patent Application Publication
(10) Pub. No.: US 2019/0129442 A1
(43) Pub. Date: May 2, 2019

(54) MAGNETIC ROBOT CALIBRATION

(71) Applicant: SPHERO, INC., Boulder, CO (US)

(72) Inventors: David Hygh, Broomfield, CO (US); Jonathan Carroll, Boulder, CO (US); Patrick Martin, Longmont, CO (US); Quentin Michelet, Arlington, VA (US)

(73) Assignee: SPHERO, INC., Boulder, CO (US)

(21) Appl. No.: 15/893,152

(22) Filed: Feb. 9, 2018

Related U.S. Application Data
(60) Provisional application No. 62/578,893, filed on Oct. 30, 2017.

(51) Int. Cl. G05D 1/02; G05D 1/00; B25J 9/16

(52) U.S. Cl. CPC G05D 1/0259; G05D 1/0011; B25J 9/162; Y10S 901/46; B25J 9/1694; B25J 9/1664; Y10S 901/01; B25J 9/161

(57) ABSTRACT

Aspects of the present disclosure relate to magnetic robot calibration. As an example, a robot may engage in a calibration process based at least in part on data samples from a magnetometer. The robot may use the data samples to determine a reference point, with which the robot may process movement instructions accordingly. In some examples, a user device may be used to control the robot, and may comprise a magnetometer for determining a reference point similar to that of the robot. As a result, the user device may communicate with the robot using movement instructions that are based on the reference point determined at the user device, such that the robot may perform the movement instructions using the reference point determined at the robot.

### CROSS-REFERENCE TO RELATED APPLICATIONS

This application claims priority to U.S. Provisional Application No. 62/578,893, entitled “Magnetic Robot Calibration,” filed on Oct. 30, 2017, the entire disclosure of which is hereby incorporated by reference in its entirety.

### BACKGROUND

A robot may operate based on a reference point, such that the robot may be able to maintain a sense of direction and navigate correctly. However, traditional calibration mechanisms to determine the reference point may require a high degree of user involvement, which may introduce additional complexity into the user's experience.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to magnetic robot calibration. As an example, a robot may engage in a calibration process based at least in part on data samples from a magnetometer. The robot may use the data samples to determine a reference point, with which the robot may process movement instructions accordingly. In some examples, a user device may be used to control the robot, and may comprise a magnetometer for determining a reference point similar to that of the robot. As a result, the user device may communicate with the robot using movement instructions that are based on the reference point determined at the user device, such that the robot may perform the movement instructions using the reference point determined at the robot.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for magnetic robot calibration.

FIGS. 2A-2C illustrate overviews of an example robot for implementing aspects of magnetic robot calibration.

FIG. 3A illustrates an overview of an example method for performing magnetic calibration at a robot.

FIG. 3B illustrates an overview of an example method for processing data samples to identify a reference point.

FIG. 3C illustrates an overview of an example method for controlling a robot using magnetic calibration at a user device.

FIG. 4 illustrates an example operating environment in which one or more of the present embodiments may be implemented.

### DETAILED DESCRIPTION

A robot may be controlled by a user device, such that a user of the user device may provide an action for the robot to perform. In an example, the user device may generate a movement instruction based on the received action, which may be communicated to the robot. The robot may then perform the movement instruction. In some examples, a movement instruction may be generated based on a reference point, such that the movement instruction may comprise a heading (e.g., an angle offset from the reference point) in which the robot should move. As an example, if the reference point is 0 degrees and the user provides an action indicating the robot should turn right, a heading of 90 degrees may be communicated to the robot, thereby causing the robot to move in a direction that is rotated 90 degrees with respect to the reference point.

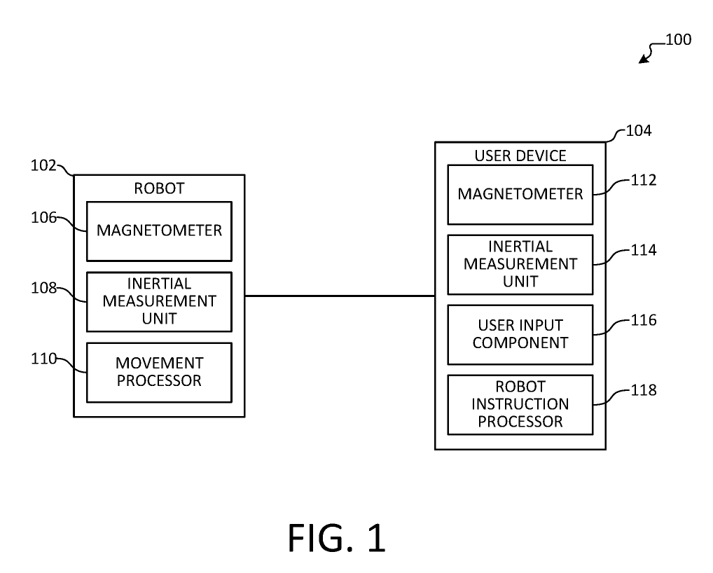

FIG. 1 illustrates an overview of an example system 100 for magnetic robot calibration. As illustrated, system 100 comprises robot 102 and user device 104. Robot 102 may be any type of remote-controlled robot, such that robot 102 may receive instructions from a user device (e.g., user device 104), and process and respond to the received instructions accordingly. In an example, user device 104 may be a mobile computing device, a tablet computing device, a laptop computing device, a desktop computing device, or a remote control, among other electronic devices. User device 104 and robot 102 may communicate using any of a variety of mechanisms, including, but not limited to, infrared or other optical communication, radio or wireless communication (e.g., Wi-Fi, Bluetooth, etc.), or wired communication.

Robot 102 may comprise magnetometer 106, inertial measurement unit (IMU) 108, and movement processor 110. In an example, magnetometer 106 may generate one or more data samples relating to the magnetic fields to which robot 102 is subject. For example, magnetometer 106 may generate data relating to the magnetic field of the Earth, magnetic fields external to robot 102, and/or magnetic fields internal to robot 102 (e.g., as may be generated by motors, electronic components, etc.). IMU 108 may generate movement and/or positional data relating to robot 102. For example, IMU 108 may comprise a gyroscope and/or an accelerometer, which may be used to determine the roll, pitch, and/or yaw of robot 102. It will be appreciated that while magnetometer 106 and IMU 108 are illustrated in system 100 as separate elements of robot 102, the functionality described herein may be provided as a single element or multiple elements in other examples.

Robot 102 may also comprise movement processor 110, which may control the movement of robot 102 and process and/or transmit data generated by magnetometer 106 and/or IMU 108. As an example, movement processor 110 may receive movement instructions from user device 104, which may be used by movement processor 110 to cause the robot to move (e.g., rotate, move in a direction or shape, etc.) using one or more motors, not pictured. In some examples, movement processor 110 may use data received from magnetometer 106 and IMU 108 to perform magnetic calibration of robot 102 according to aspects disclosed herein. In other examples, movement processor 110 may provide at least a part of the data generated by magnetometer 106 and/or IMU 108 to user device 104, which may be used by user device 104 to perform aspects of magnetic robot calibration. In another example, aspects of magnetic robot calibration may be performed using both robot 102 and user device 104.

User device 104 may comprise magnetometer 112, IMU 114, user input component 116, and robot instruction processor 118. In an example, magnetometer 112 may provide data samples relating to the magnetic fields to which user device 104 is subject. IMU 114 may generate movement and/or positional data relating to user device 104. In some examples, the functionality described herein with respect to magnetometer 112 and IMU 114 may be provided by a single element or multiple elements.

User input component 116 may receive one or more user indications relating to actions that should be performed by the robot. For example, user input component 116 may comprise a user interface, one or more physical and/or software joysticks or buttons, or arrows. Other user input techniques may be used without departing from the spirit of this disclosure. Robot instruction processor 118 may generate movement instructions, which may be provided to robot 102 to control the behavior of robot 102. As an example, robot instruction processor 118 may process indications received at user input component 116 to generate movement instructions, which may be transmitted to robot 102. Accordingly, movement processor 110 may receive the movement instruction and may control one or more motors (not pictured) of robot 102 to cause robot 102 to move. It will be appreciated that other actions may be performed without departing from the spirit of this disclosure.

In some examples, data from magnetometer 112 and/or IMU 114 may be used when generating movement instructions. As an example, if a user rotates user device 104 (e.g., moves from facing North to East), movement instructions may be generated so as to keep the direction of the robot consistent with respect to user device 104. For example, if the user is holding a forward button provided by user input component 116 while rotating 90 degrees clockwise, the robot will continue to move forward with respect to user device 104, even though the robot will turn right 90 degrees, such that it will ultimately be moving forward 90 degrees clockwise with respect to its initial movement vector.

According to aspects disclosed herein, robot instruction processor 118 may provide a calibration instruction to robot 102 (e.g., to movement processor 110 of robot 102), which may cause robot 102 to determine a reference point. In an example, robot 102 may determine the reference point by rotating while sampling data from magnetometer 106 and IMU 108. Accordingly, robot 102 may be able to identify a critical point (e.g., a maximum and/or minimum) in the magnetic field detected by magnetometer 106, such that the robot may orient itself with respect to a reference point associated with the detected magnetic field (e.g., the magnetic field of the Earth). As an example, robot 102 may determine North as the reference point (e.g., 0 degrees) based on determining the maximum of the magnetic field detected by magnetometer 106 is at a certain rotational angle with respect to the starting position of robot 102. Accordingly, movement instructions received from user device 104 may be interpreted with respect to the reference point. In such an example, a movement instruction to move forward at a heading of 90 degrees would cause robot 102 to move East in a straight line.

In an example, user device 104 may use magnetometer 106 to determine a reference point similar to that of robot 102. As an example, magnetometer 112 may be used to determine North as a reference point for user device 104, such that movement instructions generated by robot instruction processor 118 may comprise relative headings with respect to the reference point. As a result of robot 102 and user device 104 each using similar reference points, it may be possible to reliably provide relative navigation information to robot 102 based on user input received at user device 104. As compared to other solutions, determining reference points based on magnetometers 106 and/or 112 may provide more reliable data, given that magnetometers do not traditionally exhibit drift that may cause the movement accuracy of robot 102 to degrade over time. Further, magnetic robot calibration may enable an improved user experience, such that robot calibration may automatically be performed based on external information (e.g., the magnetic field of the Earth) without requesting user input relating to the rotation of the robot.

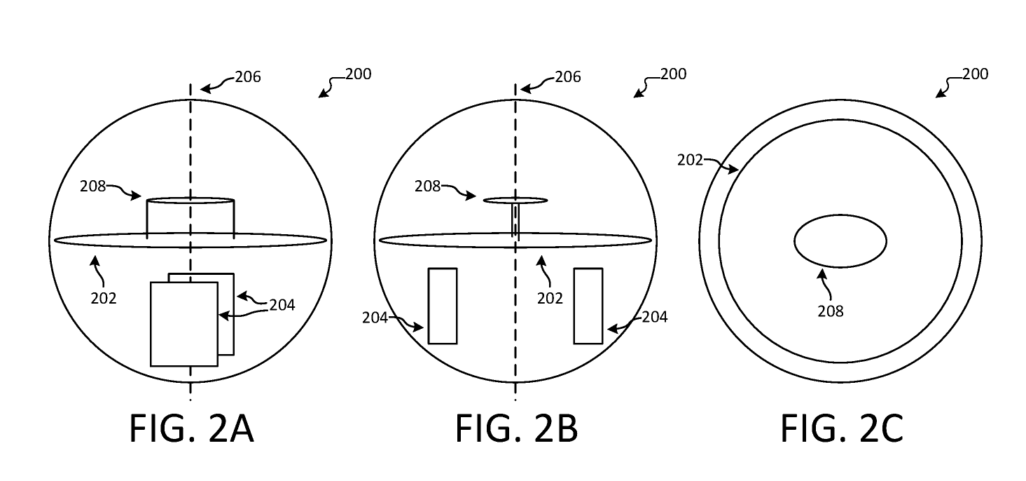

FIGS. 2A-2C illustrate overviews of an example robot 200 for implementing aspects of magnetic robot calibration. In an example, robot 200 may comprise similar elements to those of robot 102 in FIG. 1. FIG. 2A is provided as a side view of robot 200. As illustrated, robot 200 comprises circuit board 202, motors 204, and magnetometer 208. Center axis 206 is illustrated by dashed line, which may indicate the axis about which robot 200 may rotate. In an example, magnetometer 208 may be located near center axis 206, so as to reduce the variability of the magnetic fields sensed by magnetometer 208. As a result, magnetometer 208 may remain in substantially the same location as robot 200 rotates, such that local external magnetic fields (e.g., as may be caused by nearby appliances or electronics, etc.) remain relatively similar. By contrast, the magnetic field of the Earth may vary as robot 200 rotates about center axis 206. In an example, an IMU may be located near magnetometer 208, either as part of magnetometer 208 or circuit board 202. In some examples, the IMU may similarly be located near center axis 206, such that the IMU and magnetometer 208 may have substantially parallel reference axes so as to simplify certain computations.

FIG. 2B is provided as a front view of robot 200, further illustrating the position of magnetometer 208 in relation to center axis 206. In some examples, magnetometer may be located in closer proximity to motors 204 (e.g., toward and/or below circuit board 202) in order to reduce the potential effect of magnetic field sources placed close to the top of robot 200. In the instant example, magnetometer 208 is illustrated as further away from motors 204, in order to reduce the potential effect of the magnetic fields produced by motors 204 when operating and when at rest.

FIG. 2C is provided as a top-down view of robot 200, illustrating the position of magnetometer 208 in relation to circuit board 202. As discussed above, if magnetometer 208 were positioned in a less central location (e.g., near the edge of circuit board 202), additional variability of local magnetic fields may be introduced, which may impact the reliability of the data collected by magnetometer 208. It will be appreciated that while such a configuration may introduce additional variability, aspects disclosed herein may still be utilized to perform magnetic robot calibration. Further, while example robot configurations are described herein, it will be appreciated that additional, fewer, or alternative hardware components may be used without departing from the spirit of this disclosure.

While robot 200 is illustrated in FIGS. 2A-2C as being spherical, it will be appreciated that aspects of the present subject matter are not so limited. Techniques disclosed herein may be used with robots having any of a variety of shapes, including, but not limited to, a cylindrical body, a toy race car, or an action figure. In some examples, the robot may not have a motor, and may instead use other mechanisms to move. In another example, the robot may move as a result of a user moving the robot.

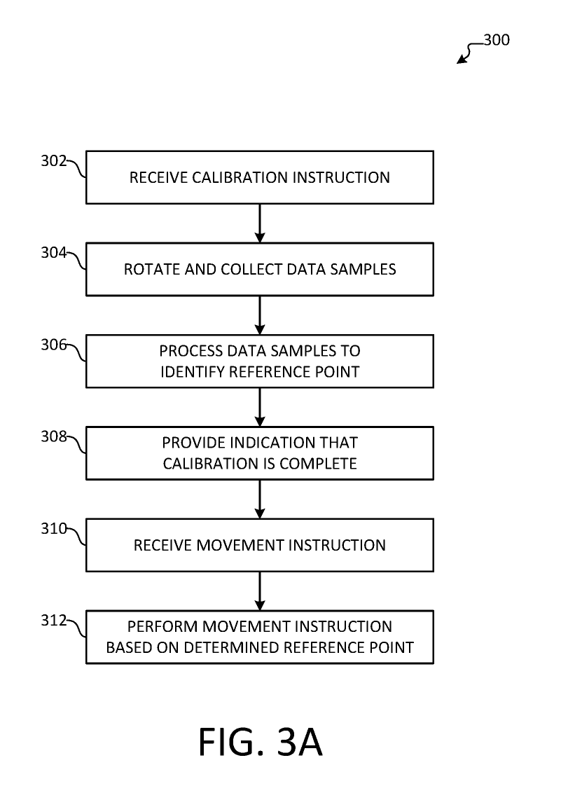

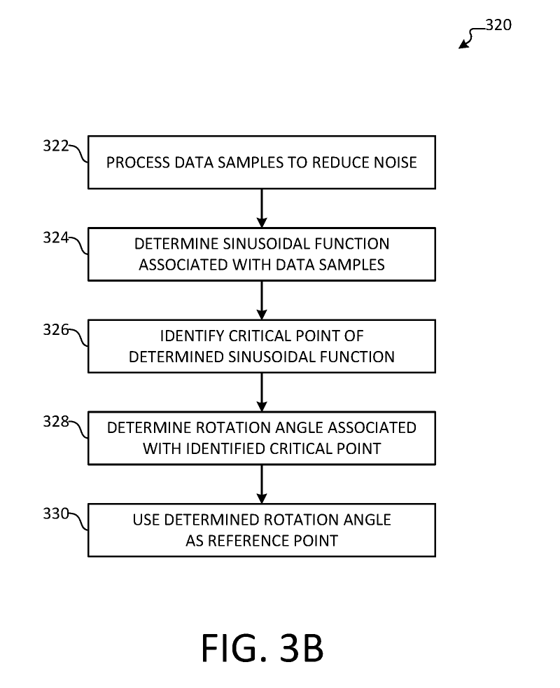

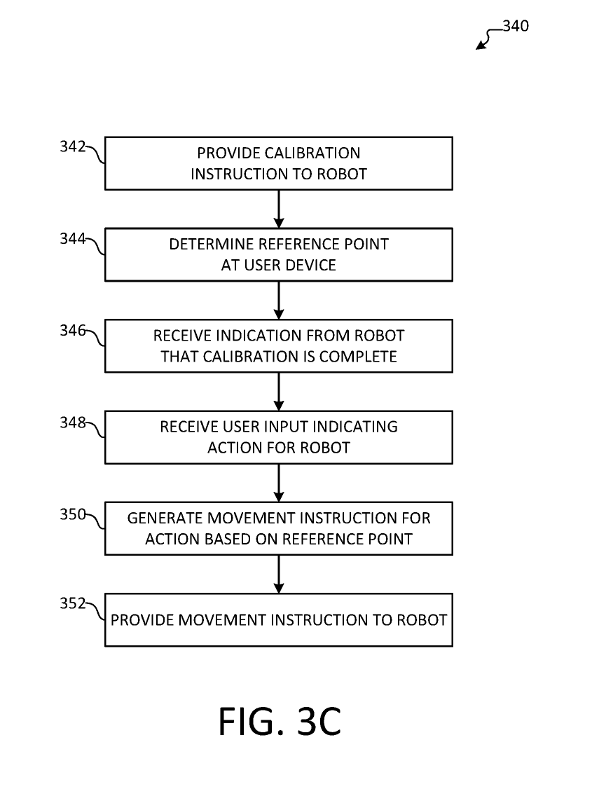

FIG. 3A illustrates an overview of an example method 300 for performing magnetic calibration at a robot. In an example, method 300 may be performed by robot 102 in FIG. 1 and/or robot 200 in FIGS. 2A-2C. Method 300 begins at operation 302, where a calibration instruction is received. In an example, the calibration instruction may be received from a user device, such as user device 104 in FIG. 1. In some examples, the calibration instruction may be received as a result of a user indication that calibration should be performed. In other examples, the calibration instruction may be received automatically (e.g., as a result of pairing the robot with the user device, as a result of turning the robot and/or user device on, etc.).

Moving to operation 304, the robot may rotate and collect data samples. In an example, data samples may be collected from a magnetometer and/or an IMU (e.g., magnetometer 106 and/or IMU 108 in FIG. 1). In some examples, rotation information may be determined for the robot using the IMU, which may be associated with data samples from the magnetometer. In some examples, the robot may rotate in a complete circle (e.g., 360 degrees), a subpart of a circle, or more than a complete circle. As an example, if the data samples are smoothed using a moving average, the robot may rotate more than 360 degrees so as to obtain additional data for the moving average computation. The robot may continually generate data samples, or may generate data samples a various intervals (e.g., every three degrees, every tenth of a second, etc.). In other examples, the robot may collect only specific samples (e.g., a sample for 10 degrees, 20 degrees, etc.), such that the robot may rotate to specific positions rather than continually rotating. In another example, data may be sampled only for a specific subset of axes from the magnetometer (e.g., for only the x-axis and/or y-axis, etc.). While examples are provided herein with respect to rotating in place (e.g., about a center axis), it will be appreciated that similar techniques may be applied to rotating about a different point either internal or external to the robot.

At operation 306, the data samples may be processed to identify a reference point. In an example, processing the data samples may comprise smoothing the data using a moving average and, in some examples, shifting the smoothed data samples to reduce potential distortion caused by the smoothing operation. In another example, a sinusoidal function may be determined, which may be used to model the data samples. In such an example, one or more critical points (e.g., a minimum and/or maximum) may be identified for the sinusoidal function, which may be used to identify a reference point. For example, as the robot rotates, the magnetometer rotates through the magnetic field of the Earth. Accordingly, the amplitude of the magnetic field detected by the magnetometer will vary in a manner that approximates a sinusoidal curve. Accordingly, the direction of the robot in relation to the poles of the Earth will correspond to one or more critical points of the sinusoidal curve. Thus, it may be possible to determine a rotation angle (e.g., in relation to the robot's starting rotation) for the robot associated with a pole of the Earth, such that the rotation angle may be used as the reference point (e.g., the rotation angle corresponding to a heading of 0 degrees). It will be appreciated that, in some examples, at least a part of the processing may be performed by a user device, such as user device 104 in FIG. 1.

Flow progresses to operation 308, where an indication may be provided that calibration is complete. In an example, the indication may be provided to a user device. The indication may comprise calibration data, such as data that was collected as part of operation 304 and/or data that was evaluated or generated as part of operation 306. In some examples, the indication may comprise an offset from the robot, wherein the offset may be in relation to the determined reference point. Thus, the IMU of the robot may retain its initial calibration rather than being reset to match the determined reference point, such that movement instructions may be processed in relation to the existing calibration of the IMU.

As an example, the robot may indicate that it will process movement instructions in relation to 20 degrees clockwise from the determined reference point. The offset may be used accordingly by the user device when generating movement instructions. As an example, if a user wishes for the robot to move straight with a heading that is 90 degrees clockwise with respect to the reference point, a movement instruction with a heading of 70 degrees may be generated and provided to the robot. Accordingly, the robot may move at a heading of 70 degrees with respect to its IMU, which is oriented 20 degrees clockwise from the reference point. In other examples, the robot may orient itself with respect to the reference point. For example, if the robot identifies North as the reference point, it may rotate such that its front is facing North.

At operation 310, a movement instruction may be received. As described above, the movement instruction may be received from a user device, such as user device 104 in FIG. 1. The movement instruction may comprise a heading, a speed, and/or a duration, among other information. Flow progresses to operation 312, where the received movement instruction may be performed based on the determined reference point. For example, the heading of the received movement instruction may be interpreted based on the reference point according to aspects disclosed herein. In another example, the interpretation may comprise also incorporating an offset used by the robot. Flow terminates at operation 312. While example movement instructions and techniques are described herein, it will be appreciated that any of a variety of other instructions and/or techniques may be used.

FIG. 3B illustrates an overview of an example method 320 for processing data samples to identify a reference point. In an example, method 320 may be performed by robot 102 in FIG. 1 and/or robot 200 in FIGS. 2A-2C. In another example, aspects of method 320 may be performed as part of operation 306, as was discussed above with respect to method 300 in FIG. 3A. Method 320 begins at operation 322, where data samples maybe processed to reduce noise. In an example, a moving average or exponential smoothing may be used. In some examples, the smoothed data may need to be shifted in order to reduce potential shift introduced by the smoothing algorithm. While example smoothing techniques are described herein, it will be appreciated that any of a variety of additional or alternative techniques may be used.

At operation 324, a sinusoidal function associated with the data samples may be determined. The sinusoidal function may be determined based on a maximum and a minimum associated with the data samples, such that an amplitude for the sinusoidal function may be determined. The sinusoidal function may be further matched to the data samples by determining a shift for the function that approximates the data samples with the lowest average distance. It will be appreciated that other techniques may be used to determine a sinusoidal function associated with the data samples without departing from the spirit of this disclosure.

Moving to operation 326, a critical point may be determined for the sinusoidal function. As an example, a maximum or minimum may be determined in order to identify the point associated with the highest or lowest magnetic field reading from the magnetometer. Flow progresses to operation 328, where a rotation angle associated with the identified critical point may be determined. As discussed above, data sampled by the magnetometer may be associated with rotation data received from an IMU. Accordingly, the sinusoidal function may be associated with rotation angles for the robot, such that the rotation angle of the robot associated with the identified critical point may be determined.

At operation 330, the determined rotation angle may be used as a reference point. This may comprise calibrating the IMU such that the determined reference point is reflected as a rotation angle of zero, or determining an offset between the IMU rotation angle and the reference point, among other techniques. It will be appreciated that while example values such as 0 degrees are used herein, aspects of the present disclosure are not so limited. Flow terminates at operation 330.

FIG. 3C illustrates an overview of an example method 340 for controlling a robot using magnetic calibration at a user device. In an example, method 340 may be performed by a user device, such as user device 104 in FIG. 1. Method 340 begins at operation 342, where a calibration instruction may be provided to a robot. In an example, the calibration instruction may be provided as a result of a user indication. In another example, the calibration instruction may be provided automatically (e.g., as a result of connecting to the robot, as a result of powering on, etc.).

At operation 344, a reference point may be determined at the user device. In an example, the reference point may be determined using a magnetometer, such as magnetometer 112 in FIG. 1. As an example, the reference point may be associated with the magnetic field of the Earth (e.g., 0 degrees may be associated with a cardinal direction, such as North). In some examples, the reference point may be determined with little to no input from a user. In other examples, the user may be prompted to move the user device in a pattern or to reorient the user device.

Moving to operation 346, an indication may be received from the robot that the calibration is complete. In some examples, the indication may comprise calibration data and/or an offset used by the robot. As an example, the robot may indicate that it will process movement instructions in relation to 20 degrees clockwise from a reference point. In other examples, the indication may indicate the current heading of the robot in relation to a reference point. It will be appreciated that the indication may comprise any of a variety of other information.

At operation 348, user input may be received indicating an action for the robot. In an example, the user input may be received by user input component 116 in FIG. 1. In some examples, the user input may comprise a user interaction with one or more hardware buttons and/or user interface elements of the user device. In some examples, the user indication may comprise a direction and/or a speed for the robot.

Flow progresses to operation 350, where a movement instruction for the action may be generated based on the reference point. In an example, the movement instruction may comprise a heading, a speed, and/or a duration, among other information. As an example, the heading may be determined based on the reference point determined at the user device and/or information from an IMU. For example, if the user indicates that the robot should move straight and the user device is oriented such that straight is toward the reference point, the generated heading may 0 degrees. In another example, if the user indicates that the robot should move left and the user device is oriented such that the reference point is to the right, the generated heading may be 180 degrees. It will be appreciated that values discussed herein are provided as examples and are not intended to limit the scope of the present subject matter. In some examples, an offset (e.g., as may have been received at operation 346) may also be used to generate the movement instruction according to aspects disclosed herein.

Moving to operation 352, the movement instruction may be provided to the robot. In an example, providing the movement instruction may comprise communicating the movement instruction using a wireless radio, a wired connection, or infrared or other optical communication, among other techniques. Flow terminates at operation 352.

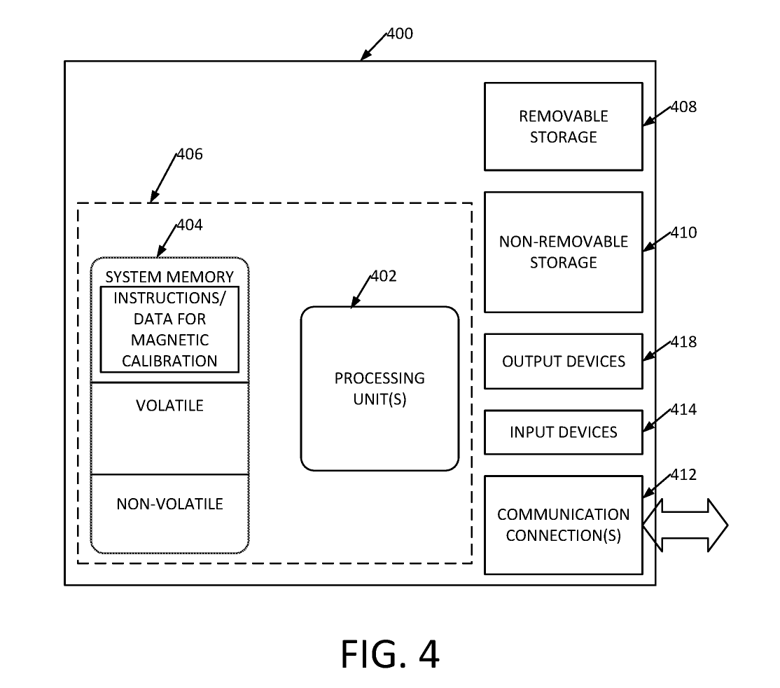

FIG. 4 illustrates an example operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically includes at least one processing unit 402 and memory 404. Depending on the exact configuration and type of computing device, memory 404 (e.g., instructions to perform the magnetic robot calibration techniques described herein) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 typically includes at least some form of computer readable media. Computer readable media can be any available media that can be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a system for magnetic calibration of a robot, comprising: at least one processor; and memory encoding computer executable instructions that, when executed by the at least one processor, perform a method. The method comprises: collecting a set of data samples from a magnetometer while the robot rotates; generating a sinusoidal function associated with the set of data samples; determining a reference point using the sinusoidal function, wherein the reference point is associated with a rotation angle of the robot at a critical point of the sinusoidal function; receiving a movement instruction from a user device, wherein the movement instruction comprises a heading; and performing the movement instruction by evaluating the heading using the reference point. In an example, collecting the set of data samples from the magnetometer further comprises associating the samples with data from an inertial measurement unit. In another example, the rotation angle of the robot at the critical point is measured by the inertial measurement unit. In a further example, the method further comprises recalibrating the inertial measurement unit based on the reference point. In yet another example, the rotation angle is stored as an offset, and wherein evaluating the heading using the reference point comprises evaluating the heading based on the offset. In a further still example, the method further comprises: receiving a calibration request from a user device; and in response to the calibration request; providing the offset to the user device. In another example, generating the sinusoidal function associated with the set of data samples comprises at least one of: removing noise from the set of data samples; and performing a smoothing operation on the set of data samples.

In another aspect, the technology relates to a computer-implemented method for controlling a robot. The method comprises: providing a calibration indication to a robot, wherein the calibration indication causes the robot to determine a first reference point for the robot; determining, at a user device, a second reference point based on a magnetometer of the user device; generating a movement instruction for the robot based on a user input, wherein the movement instruction comprises a heading based on the second reference point; and providing the generated movement instruction to the robot. In an example, the user input comprises at least one of a speed for the robot and a direction for the robot. In another example, the method further comprises: receiving, in response to providing the calibration indication, an offset from the robot. In a further example, the movement instruction is generated based on the received offset. In yet another example, the second reference point is determined based on a rotation angle from an inertial measurement unit. In a further still example, the second reference point is determined based on a rotation angle from an inertial measurement unit. In another example, the method further comprises: receiving, from the robot, a set of data samples from a magnetometer of the robot; and determining, based on the set of data samples, an offset for the robot.

In a further aspect, the technology relates to another computer-implemented method for controlling a robot. The method comprises: determining an offset relating to a robot in relation to a first reference point; determining, at a user device, a second reference point based on a magnetometer of the user device; generating, based on user input, a movement instruction for the robot comprising a heading based on the second reference point and the received offset; and providing the generated movement instruction to the robot. In an example, the second reference point is determined based on a rotation angle from an inertial measurement unit. In another example, determining the offset relating to the robot comprises receiving the offset in a response from the robot, and wherein the response is in response to a calibration indication provided to the robot. In a further example, determining the offset relating to the robot comprises: receiving, from the robot, a set of data samples from a magnetometer of the robot; and determining, based on the set of data samples, the offset for the robot. In yet another example, determining the offset relating to the robot further comprises at least one of: removing noise from the set of data samples; and performing a smoothing operation on the set of data samples. In a further still example, the first reference point and the second reference point correspond to a similar cardinal direction.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system for magnetic calibration of a robot, comprising:
at least one processor; and
memory encoding computer executable instructions that, when executed by the at least one processor, perform a method comprising:
collecting a set of data samples from a magnetometer while the robot rotates;
generating a sinusoidal function associated with the set of data samples;
determining a reference point using the sinusoidal function, wherein the reference point is associated with a rotation angle of the robot at a critical point of the sinusoidal function;
receiving a movement instruction from a user device, wherein the movement instruction comprises a heading; and
performing the movement instruction by evaluating the heading using the reference point.

2. The system of claim 1, wherein collecting the set of data samples from the magnetometer further comprises associating the samples with data from an inertial measurement unit.

3. The system of claim 2, wherein the rotation angle of the robot at the critical point is measured by the inertial measurement unit.

4. The system of claim 3, wherein the method further comprises recalibrating the inertial measurement unit based on the reference point.

5. The system of claim 1, wherein the rotation angle is stored as an offset, and wherein evaluating the heading using the reference point comprises evaluating the heading based on the offset.

6. The system of claim 5, wherein the method further comprises:
receiving a calibration request from a user device; and
in response to the calibration request; providing the offset to the user device.

7. The system of claim 1, wherein generating the sinusoidal function associated with the set of data samples comprises at least one of:
removing noise from the set of data samples; and
performing a smoothing operation on the set of data samples.

8. A computer-implemented method for controlling a robot, comprising:
providing a calibration indication to a robot, wherein the calibration indication causes the robot to determine a first reference point for the robot;
determining, at a user device, a second reference point based on a magnetometer of the user device;
generating a movement instruction for the robot based on a user input, wherein the movement instruction comprises a heading based on the second reference point; and
providing the generated movement instruction to the robot.

9. The computer-implemented method of claim 8, wherein the user input comprises at least one of a speed for the robot and a direction for the robot.

10. The computer-implemented method of claim 8, further comprising:
receiving, in response to providing the calibration indication, an offset from the robot.

11. The computer-implemented method of claim 10, wherein the movement instruction is generated based on the received offset.

12. The computer-implemented method of claim 8, wherein the second reference point is determined based on a rotation angle from an inertial measurement unit.

13. The computer-implemented method of claim 8, wherein the first reference point and the second reference point correspond to a similar cardinal direction.

14. The computer-implemented method of claim 8, further comprising:
receiving, from the robot, a set of data samples from a magnetometer of the robot; and
determining, based on the set of data samples, an offset for the robot.

15. A computer-implemented method for controlling a robot, comprising:
determining an offset relating to a robot in relation to a first reference point;
determining, at a user device, a second reference point based on a magnetometer of the user device;
generating, based on user input, a movement instruction for the robot comprising a heading based on the second reference point and the received offset; and
providing the generated movement instruction to the robot.

16. The computer-implemented method of claim 15, wherein the second reference point is determined based on a rotation angle from an inertial measurement unit.

17. The computer-implemented method of claim 15, wherein determining the offset relating to the robot comprises receiving the offset in a response from the robot, and wherein the response is in response to a calibration indication provided to the robot.

18. The computer-implemented method of claim 15, wherein determining the offset relating to the robot comprises:
receiving, from the robot, a set of data samples from a magnetometer of the robot; and
determining, based on the set of data samples, the offset for the robot.

19. The computer-implemented method of claim 18, wherein determining the offset relating to the robot further comprises at least one of:
removing noise from the set of data samples; and
performing a smoothing operation on the set of data samples.

20. The computer-implemented method of claim 15, wherein the first reference point and the second reference point correspond to a similar cardinal direction.
